(19) United States
(12) Patent Application Publication
(10) Pub. No.: US 2004/0172412 A1
(43) Pub. Date: Sep. 2, 2004

(54) Automated configuration of packet routed networks

(76) Inventors: Kirby Files, Milton, MA (US); Ron E. Haberman, Fairfax, VA (US); Klyne L. Smith, Memphis, TN (US); Karen E. Krickus, Richmond, VA (US); Guy J. Rouillier, Silver Spring, MD (US); David Steele, Chantilly, VA (US); Jason Collins, Springfield, VA (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/622,410

(22) Filed: Jul. 18, 2003

Related U.S. Application Data
(60) Provisional application No. 60/397,109, filed on Jul. 19, 2002.

(51) Int. Cl. G06F 17/00

(52) U.S. Cl. 707/104.1

(57) ABSTRACT

Detailed configurations for specific network elements are automatically generated and, if desired, automatically activated in response to an addition, modification and/or deletion of a network service or topology specified at high level. Network configuration information is stored in a database. Metadata, including descriptions of network elements, properties of network elements and relationships between network elements, is used to describe network topologies. Data fields described the metadata store current configuration data for each network element.

### RELATED APPLICATIONS

This patent application claims the benefit of Provisional Patent Application, Serial No. 60/397,109, entitled Automated Configuration of Packet Routed Networks, filed on Jul. 19, 2002, the disclosure of which is incorporated herein by reference.

### TECHNICAL FIELD OF THE INVENTION

The invention pertains generally to provisioning of packet routed networks.

### BACKGROUND OF THE INVENTION

With the availability of various types of network engineering and quality of service (QoS) mechanisms, packet routed networks, in particular those using the Internet Protocol, are increasingly being used to implement wide area networks that provide differentiated, end-to-end transport services. Such networks have several advantages. As compared to other types of networks, such networks can handle differentiated traffic relatively efficiently. They are also relatively inexpensive to build and can be run over heterogeneous infrastructures.

### SUMMARY OF THE INVENTION

Configuring network elements in a packet routed network can however be a relatively complex task, especially when a network is comprised of heterogeneous types of equipment from different vendors.

The invention has as a general objective reducing the complexity of changing configurations in individual network elements in packet routed networks for purposes of adding or changing logical links or topologies, specifying bandwidths, and adding, changing or deleting the types of service run over links. Reduced complexity not only reduces burdens on network engineers, administrators and operators in making changes, but also enables, if desired, customers or users of services on such networks to undertake at least a certain level of provisioning, with little to no intervention by those who operate the network.

Various aspects and features of the invention, in their preferred embodiments, are described below with reference to an exemplary network element management system implementing them. Some of these aspects are briefly summarized below, with the understanding that the summary is not intended to limit the scope of the invention as claimed.

According to one aspect, detailed configurations for specific network elements are automatically generated and, if desired, automatically activated in response to an addition, modification and/or deletion of a network service or topology specified at high level. Examples include, but are not limited to, a new or changed point-to-point link and/or bandwidths and service treatments (e.g. a specified quality of service) on those links.

A customer or other user of a network may thus be permitted to add, drop and modify their own network topology and services relatively frequently, as conditions or its needs change, without the customer having direct access to the network elements. In other words, they may be permitted to take care of at least some of the network provisioning. A customer could, for example, specify a new link between two sites, having a certain bandwidth for voice traffic and a certain bandwidth for priority data traffic. The link could be implemented by establishing, for example, a label switched path through the network using MPLS, and configuring QoS mechanisms in affected routers treat traffic according to the selected service levels.

According to another aspect, the service changes could be specified interactively through, for example, a web portal, with the configurations being automatically generated and activated on affected network elements. For customers, a Web portal may also include lists of current services, traffic statistics for those services, and other information (e.g. account and billing). A customer is thus able to monitor traffic in addition to relatively easily changing network topology and services to meet its requirements.

According to another aspect, network configuration information or data is stored in a database using a vendor-independent schema, and actual configurations generated and transferred to network elements using this information. The network configuration information is not the specific data stored on the network elements or devices. Rather, information necessary for configuring specific network elements or devices is stored. Preferably, each type of network element is modeled or defined using a metadata language that defines each type of network element in terms of configuration data fields, properties, and/or relationships to other elements. The metadata thus specify what configuration data or other information is stored for each specific type of element.

According to yet another aspect, logic specific for each type of network element and service to be implemented on the device populates the actual configurations with data from the database. A generic configuration template, containing fixed or unchanging text, forms a basis for the configuration prior to populating it with data. Instructions implementing this logic are preferably specified at a relatively high level using an interpreted script language that can be easily learned and used by non-programmers. Changes in the logic can thus be easily implemented without changing the programming code of a software engine that executes the logic by reading the script. The logic preferably also indicates how to activate the configuration.

The invention is described below, with reference to the accompanying drawings, with respect to an exemplary network element management system implementing various aspects and features of the invention in its preferred embodiment. The invention is not, however, limited to this specific example.

### BRIEF DESCRIPTION OF THE DRAWINGS

FIG. 1 is a block diagram of a packet routed network and a network element management system for generating configurations for elements in the network.

FIG. 2 is a flow diagram of steps in a process for adding, modifying or canceling services on a packet routed network.

FIG. 3 is a flow diagram of steps for a process of auditing configurations of network elements.

FIG. 4 is a schematic representation of the database schema for databases used in the network element management system of FIG. 1

FIG. 5 is a flow diagram of a process for generating a device-specific configuration in response to a request to add, modify or delete a specific service, using activation scripts and templates.

FIG. 6 is a flow diagram of the basic steps of defining an activation script for a new type of service for a network.

FIGS. 7-13 are screen shots of an example of a customer portal for specifying additions, modification and deletions to network services and links.

### DETAILED DESCRIPTION OF THE DRAWINGS

In the following description, like numbers refer to like elements.

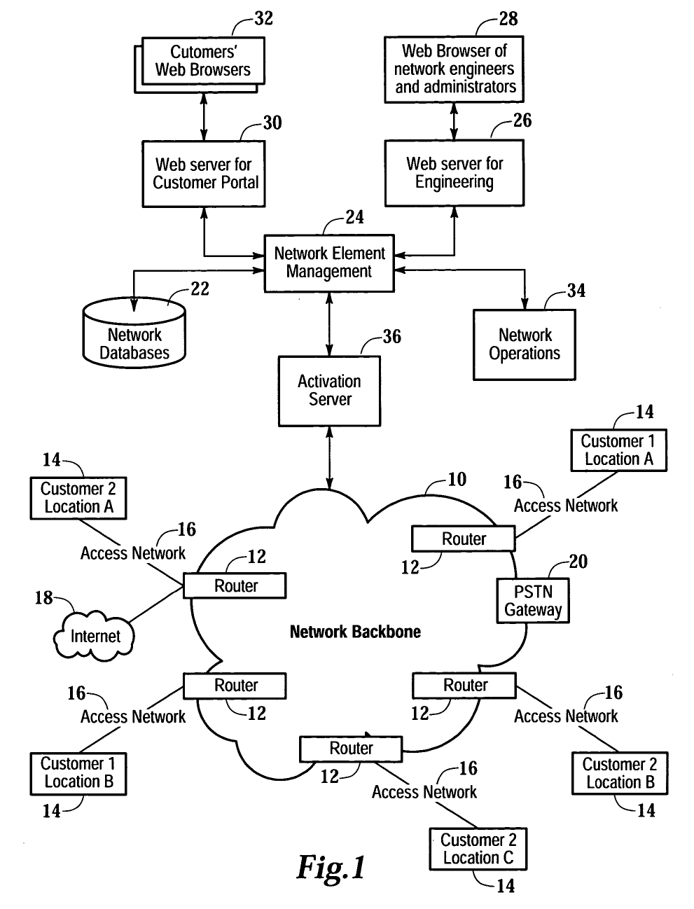

Referring to FIG. 1, network 10 is a representative example of a backbone network 10 in which packets are routed. The network includes a plurality of edge routers 12, in addition to core routers, which are not shown. The routers are intended to be representative generally of elements in the network. Other network elements might include switches, network interfaces, and other equipment depending on the types of link layer networks used. Although multiple different types of link layers can be used, the backbone network can also be comprised of a homogeneous infrastructure. As an example only, a plurality of customer sites 14 are shown connected to backbone network 10. Although the invention contemplates a service provider operating the network and selling services to third parties, the invention could be deployed in a wide area network operated by an enterprise, with various constituencies within the enterprise being, in effect, customers of the network. Thus, “customers” will refer to any type of consumer of network services, unless the context indicates otherwise. The sites connect to edge routers 12 on backbone network 10 through access networks 16. The access networks may be, for example, a single TI or frame relay line, or an Ethernet connection. Customers may use backbone network 10 to create a wide area network connecting multiple sites, as shown, to connect to Internet 18, the public telephone switched networks (PSTN) through gateway 20, and/or to other networks, and/or for other purposes. These are just examples of network elements that may be present in such a packet routed network.

For example, the network may allow for private links to be set up or changed between customer sites, thus permitting a logical network topology to be established for a customer and changed. Various types of transport services may be offered or implemented by backbone network 10. It may also have predefined tiered service planes, with different quality of service. Examples of such service planes are normal or best effort for lowest priority traffic; priority data for data applications, with traffic being classified low, medium or high; reserved bandwidth for critical data applications that require assured bandwidth; video, with reserved bandwidth with videoconferencing-quality latency, jitter packet delivery; and voice, with reserved bandwidth with voice-quality latency, jitter and packet delivery. For each of these services a customer may specify parameters, such as a bandwidth for those services with reserved bandwidth and the customer's sites between which the service will be offered. These are just examples that will be referenced in the following description. A network operator may define fewer or more service tiers. Additional services may also be offered.

Information, including configuration data, for one or more of the network elements in backbone network 10 and/or access networks 16 is stored in network databases 22 of network element management system 24. In a preferred embodiment, configuration data does not consist of the complete configuration files stored in each of the network elements. Rather, it is data that is defined to be stored on each network element in the network. Database 22 is representative of one or more databases, which may be distributed and which may also exist in multiple instances. Preferably, and in the example given below, the network databases store information on the entire network. However, they could just store information on subnets or parts of the network, depending on the purpose for which they are used.

The network element management system 24 represents one or more software controlled processes on one or more programmable computers. In the preferred embodiment, it represents several different software controlled processes for implementing different functions, tied together with core logic. However, the software controlled processes may be implemented in different processing entities. It is therefore not limited to any particular implementation, and any reference to the network element management system should not necessarily be construed to be a reference to a system implementing all of these functions.

One of these functions is creating, accessing and modifying information on the network stored in the network databases 22, including configuration data for network elements. The logical structure for implementing this function may be referred to as a database engine, and be implemented separately from the core logic of the system as software controlled processes.

Another function, which is described in greater detail below, is generation of specific configurations for network elements based on relatively high level information specifying a service or other network function, which high level information is provided by a user. The logic for this function, preferably implemented using software executing on a computer, may be referred to herein specifically as a configuration generator.

Personnel may have access to network element management system for purposes of generating configurations, as well as for updating the network databases 22 or other logic contained in the system. This may be done, for example, through web server 26 and a web browser 28, though other access methods can be used, giving direct access to the network element management system, or modules or components thereof, with access to network databases 22. Multiple instances of the network element management system can also be run. Similarly, network operations 34, which may be individuals or programs used in network operations, may have access to the network configuration information for purposes of obtaining information on current network topology, as well as automatically generating configurations in network elements for traffic monitoring or other purposes. Although not shown, network operations personnel may have access to the network element management system 24 through a web portal or other user interface, preferably a graphical one for simplicity of use.

In the preferred embodiment shown, customers or users of network services may indirectly access the network element management system through an interactive portal available on web server 30 using web browsers 32 executing on the customers computers. Though this portal is a preferred method for providing access, other methods can be used, including client applications executing on the customers computers or even instances of the network element management system or one or more of its components. The portal allows customers to add, modify or delete services. Services are specified at a high level, preferably in reference to predefined services. For example, a customer may add a link between two of its sites by specifying the two sites and a service plane. Examples of predefined service planes include the examples given above: normal, priority, reserved bandwidth, voice or video. One or more parameters can be specified, such as bandwidth, whether the link is shared or reserved, and priority levels. Access speed or bandwidth tiers could also be specified for the customer's access network or line. Enhancements for the services could also be specified. The portal could also be used to provide a summary of the customer's services and usage statistics and billing and account information. For purposes of the example described herein, the software controlled processes for interacting with the web server is included in the network element management system 36, though it could be separated.

A single instance of the network element management system could be used for interacting with both network engineering and the customer and executing the activation function. However, it is preferred that a separate instance, referred to as the activation server, execute activation of new configurations in network elements in order to provide much stricter access and tighter security, and additional logging and auditing. Other instances of the network element management system can be provided for use by network engineering, administration and operations. Activation server 36 is, in the preferred embodiment, a second instance of the network element management system, or at least certain processes of the network element management system, that permit it to generate configurations using data or information supplied by a customer, or network engineering or operations, which then activates on network elements. The logical and physical elements for this activation function may be referred to herein as an activation engine or mechanism and are implemented preferably as software controlled computing processes executing, for example, on a computer.

Once generated by the activation server, configurations are then communicated to network elements using any available communication mechanism for that network element. Examples of such mechanisms include FTP, Telnet, and SNMP. The exact method of communication and update or changing configurations depends at least in part on the specific network element involved. The activation engine enables all changes to be made consistently across the network, preferably with comprehensive logging. The configurations may relate not only to service activation, but also application of security policies and network maintenance, including collecting performance monitoring information to give to a customer or network operations. The activation server may thus be used by those who run the network for tracking and configuring network elements.

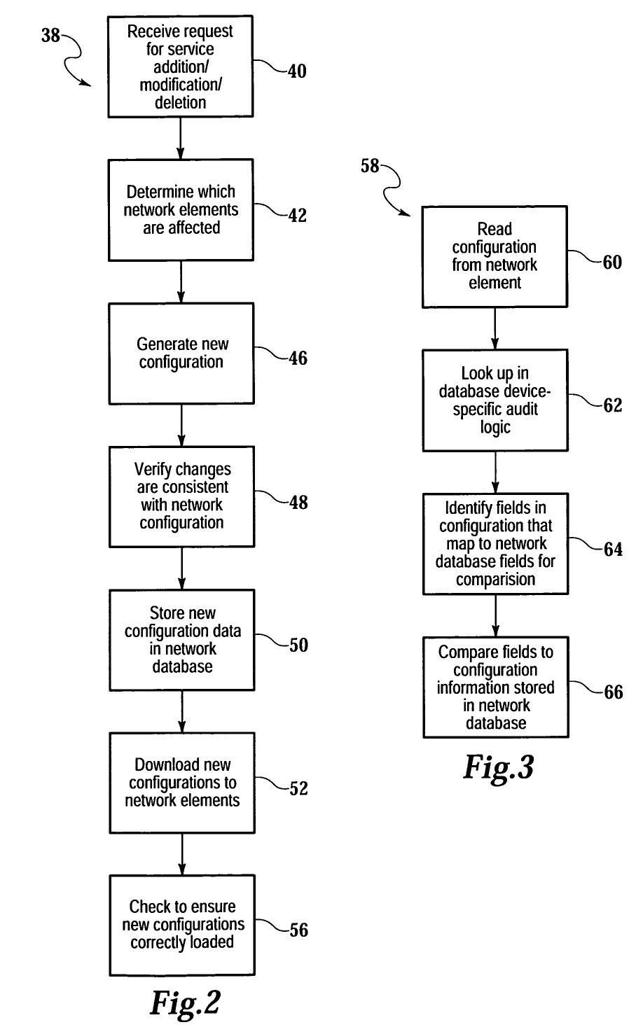

Referring now also to FIG. 2, an exemplary process flow 38 for a service addition, modification or cancellation starts with receiving a request for service addition, modification or deletion at step 40. If the request comes in through an interactive portal, such as web server 30 for customer portal 30 or the web server for engineering 26, or directly from an instance of the network element management system 24, it is handled by logic that specifies how each type of service request is to be handled. The logic may be implemented as instruction scripts and stored as part of the network databases 22. For purposes of this description, the logic will be treated as part of network element management system 24 or activation server 36. In the illustrated example, service requests are passed to the activation server 36. The location of execution of the logic depends on the particular implementation and is not critical. Indeed, it may take place in multiple places. The logic determines at step 42 which network elements are affected by the change, relying on information in network databases 22 for making this determination. Some service requests may only affect devices on the edge of a network and others may affect core devices.

At step 46, the logic generates configurations for each affected network element. The term “configuration” does not necessarily refer to the entire configuration of a network device. Rather, it may also refer to a configuration of a particular feature or set of features, or incremental changes to the configurations such as a new logical interface or access list of a router. The entire configuration of the element need not be regenerated, unless required by that particular element.

In a preferred embodiment, a configuration is built from predefined template fragments and populated using configuration data taken from the network database 22. This data may include specific configuration data for each element, including data provided by the party requesting the service addition, modification or deletion (e.g. bandwidth and other service parameters).

It is also preferred to use a script to, at least in part, define the logic or process by which a configuration is generated and/or activated on the network element. Use of a script and predefined templates fragments permits new services and equipment to be added without requiring software to be modified and recompiled. Scripts can be created by non-programming network engineers administrators to define steps at relatively high level. Use of configuration data and script permits the network element management system to be neutral or independent of the particular requirements of a piece of equipment, as those requirements can be handled in the scripts and/or template fragments. For an operator of a network, this permits vendor-independence. Equipment from different vendors can therefore be supported by the network. Furthermore, the scripts may make use of abstract network topology or connectivity data stored in the database, which enables creation of logic for generating a configuration that is independent of specific network topology. New types of equipment can be added, or equipment changed, relatively quickly.

If desired, the activation can be queued for later execution. All outstanding configuration activations could be run at the same time, such that a networks configuration only changes once a day, for example. However, the service activation could also be executed quickly, appearing in effect in “real time” once the request is made.

Before a configuration is activated on a network element, it is checked at step 48 to make sure that it is generally consistent with the configuration of the network. This verification step relies on network configuration data in network databases 22, and reduces the risk that the new configuration inadvertently is inconsistent with the configuration of the network. Once verification is made, step 50 involves updating the network databases with data on the new configurations. The activation server then downloads or communicates the new configurations to the affected network elements at step 52, and then checks the configurations of the network elements to determine that they have correctly loaded at step 56.

With the process shown in FIG. 2, a person with no or little knowledge can implement service requests, with little or no intervention by a network engineer or administrator. For a customer of transport services, service additions, modifications and cancellations can be made relatively quickly, perhaps even in real time, without direct access to the network elements. The customer requests service modification, addition or deletion, a new configuration is automatically generated for the affected network elements and then automatically activated in the network elements.

FIG. 3 is a flow diagram of an auditing process 58 that confirms that the configurations of the network elements are consistent with the configuration data stored in network databases 22 (FIG. 1). This process is, in the example, executed by the activation server 36 (FIG. 1), but it could be implemented as a separate process. Unlike other auditing processes, which simply read configurations out of each network element and compare them line by line to a stored configuration to detect any changes or corruption, audit process 58 compares the configurations in the network elements to data on the configuration stored in network database for that network element. That data stored in the network database is stored in multiple fields. Logic is used to extract from the configurations the values that correspond to the data values stored in the network database. Thus, at steps 60 and 62, which can be executed in any order, the audit process reads the configuration from the network element and looks up device-specific audit logic in the database. This audit logic is, in the example, stored in the network databases 22 as a template or script. Step 64 involves identifying the fields or data values in the configuration that map to fields in the network databases that store configuration data for the particular device. The data values are then compared at step 66. Exceptions can then be generated for investigation.

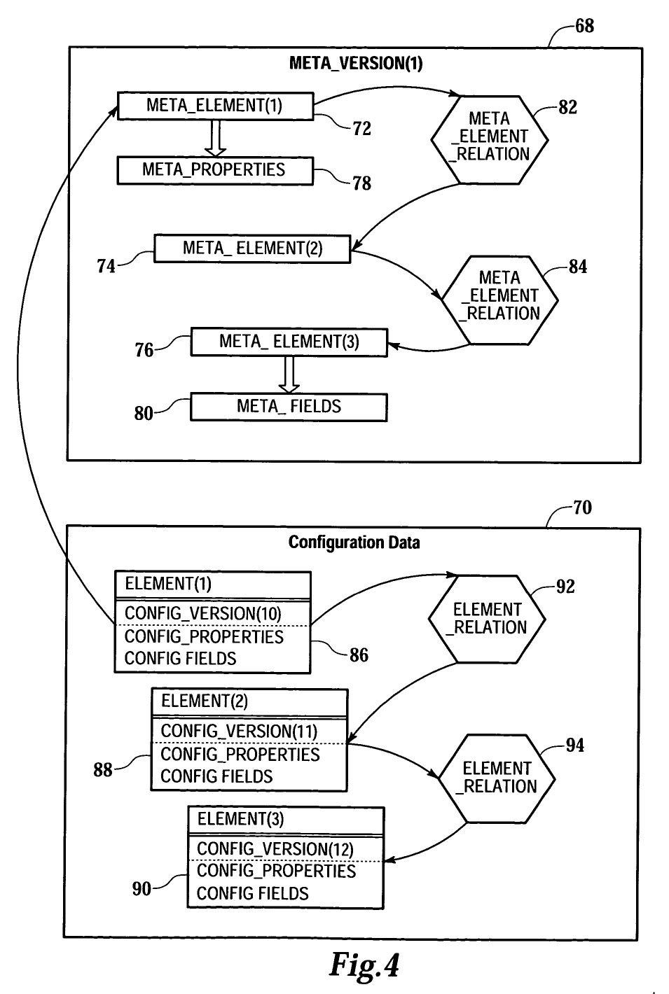

Referring now to FIG. 4, in the preferred embodiment, metadata is used to describe or model network elements and the topology of a network, such as network 10 of FIG. 1, at an abstract level. This metadata is then used to define the schema with which actual data, including, but not limited to, what is referred to above as configuration data, for actual elements in the network is stored. This data on the elements actually present in the network may also be referred to herein as network element inventory data or network inventory data. The metadata is preferably written using a language that is easily understood or learned by network engineers and administrators. Metadata model 68 is a very simple example intended only to illustrate and explain the concept and relationship between the metadata description or model of the network and data records, such as configuration data records 70. Both the metadata description or model and the configuration data records would be, in the preferred embodiment of FIG. 1, stored in network databases 22. The network element management system 24 would rely on the metadata in generating and activating configurations. Thus, changes to a network in terms of new types of services or elements can be relatively easily added without having to change any software. Fields of configuration data required are specified using the metadata and simple scripts can be written with reference to the metadata to specify how the configurations are generated and activated. No changes to the programming code are required.

Metadata includes entities designated as “meta_elements”, three of which are identified by reference numbers 72, 74 and 76 in the example. Associated with each of the meta elements are “meta_properties” and/or “meta_fields”. In the illustrated example, meta_element 72 has associated with it meta_Properties 78, and meta_element 76 has associated with it meta_fields 80. The meta elements may be related to each other using “meta_element_relation” objects. These specify a relationship between elements. Meta_element_relation 82 relates meta_element 72 to meta_element 74. Similarly, meta_element_relation 84 relates meta_elements 74 and 76. Preferably, meta_element_relations may not only specify the existence of a relationship, but also its nature. For example, it is preferable to be able to define a relationship as being a parent-child, a sibling or a peer relationship.

Thus, for example, the metadata describes how to define a network element, such as a router. Furthermore, it provides an abstract description of a network's topology, with relationships between the different types of network elements. As an example, a particular type of router from a particular vendor may be defined as a meta_element. This type of router may be able to accept different types of physical network interfaces. Each network interface could be a separate meta_element with a parent-child relationship with the router meta_element. The meta_element for the router might then be a child to a meta_element defining a network, or a subnet.

Examples of meta_properties include, but are not limited to, captions or information shown in user interfaces, help strings that would be displayed in user interfaces, whether or not meta element has a template, whether or not it is a connectable type of element, whether or not the element has been accepted by operations, whether the device is activated, and which version of the metadata the device is operating off of. Examples of meta_fields include, but are not limited to, framing, encryption settings, the name of a logical interface, a name of device, its serial number, routing information, information for QoS mechanisms, and whether it is under maintenance contract. Thus, any type of data could be specified to be stored, including not only data need for generating configurations, but also data for use in operations.

Configuration data records 70 include data for actual network elements. The data schema for these records map to the metadata definitions for the type of network element. Thus, records 86, 88 and 90 have structures that map, in the given example, to meta_elements 72, 74 and 76, and have relationships 92 and 94 specified by meta_element_relations 82 and 84. The configuration data records are used in generating actual device configurations.

Multiple, different instances of metadata models of the network and network elements and instances configuration data can be stored if desired, with one model and instance of configuration data being active.

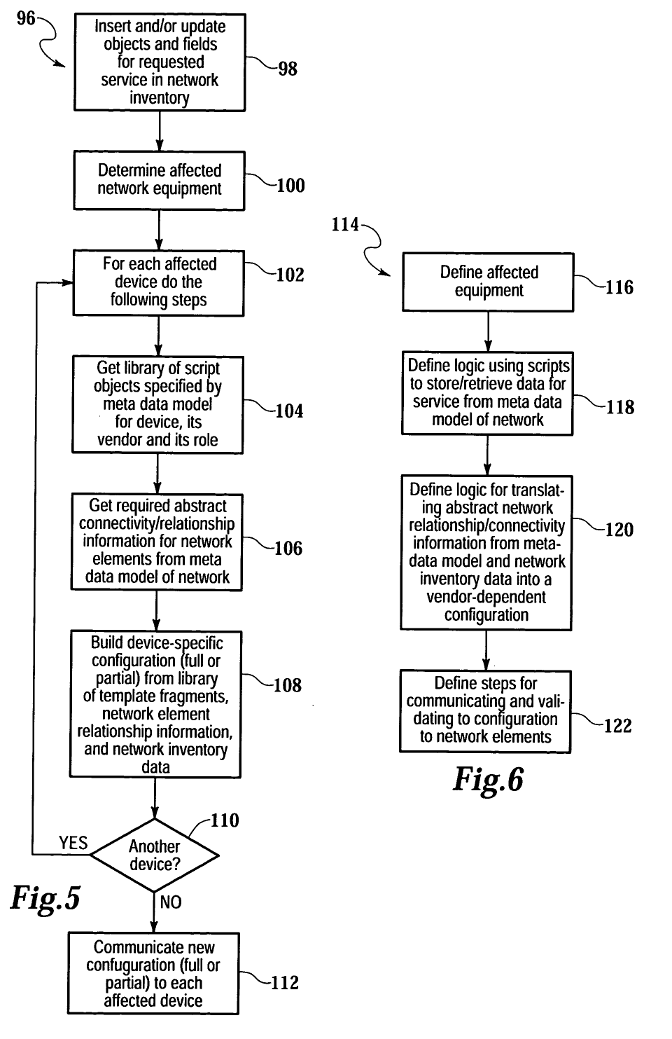

FIG. 5 illustrates a process 96 by which new or modified service request is activated by the network element management system 24 or 36 using a script. The scripts, which in a preferred embodiment will be called activation scripts herein, specify the logic for translating service requirements into configurations and deployment. Scripts further permit modularization of the service activation logic. Such modules may be referred to as script objects.

At step 98, after a service request is received, objects and fields for the requested service are added and/or updated in the network inventory stored in the network database 22 (FIG. 1). Information on each specific service provided to a user or customer of network is preferably stored prior to the service being activated. The network equipment affected by the change is determined at step 100 and, as indicated by steps 102 and 110, steps 104, 106, and 108 are repeated for each device.

At step 104, script objects are retrieved from a library of such objects based on the type of device, its vendor and its role. Script objects are device and vendor specific scripts that may be used by a new service script. Abstract network topology information, or more generally, abstract connectivity/relationship information, for the affected network device or element is obtained at step 106. This information is preferably from a metadata model of the network. This data specifies how network elements are, at an abstract level, connected and work together. The scripts can therefore be written without knowing the specific network topology, and changes to network topology made without having to rewrite scripts.

Step 108 involves building a device-specific configuration from a library of template fragments, the abstract connectivity/relationship information and the network inventory data for the specific device and service. The configuration may be a partial or full configuration. The necessary template fragments, which are predefined configuration text stored in a database such as network database 22 (FIG. 1), are selected by the script, assembled into a template and populated with the device and service specific network inventory data. The fragments preferably include tokens that act as place holders for the specific data to be inserted The population of the templates may be performed in two steps, with the second step involving populating the template with global network inventory data common to all configurations using a standard script objects. After the configuration for an affected device is generated, it is communicated at step 112 to the device. After communication, the new configuration is validated. It is preferable that configurations for all affected devices be generated prior to communicating them to any of the devices.

In sum, the templates and activation process are preferably data-driven. That is to say, none of the configurations, network configuration data, script logic is inherent in the software for the network element management system. It is stored in and retrieved from a database, such as network database 22, using metadata. Software for the network element management system can thus be made vendor-neutral, with scripts specifying the vendor- and product-dependent configuration logic. The addition of a new service thus requires no changes to the management system software.

FIG. 6 illustrates basic steps of a process 114 for adding a new type of service to a network managed by the network element management system using activation scripts. At step 116 logic for selecting equipment affected by an addition, modification or deletion of the service for a specific customer is specified. Processes for storing and retrieving data on the connectivity/relationships of network elements is specified at step 118. This data is, as previously mentioned, the metadata used to create an abstract definition of the network. Step 120 involves defining logic for translating abstract network connectivity/relationship information or data and network inventory data into a vendor-dependent configuration for each affected device. The final basic step 122 includes defining how the configurations are to be communicated to the affected network devices and validated.

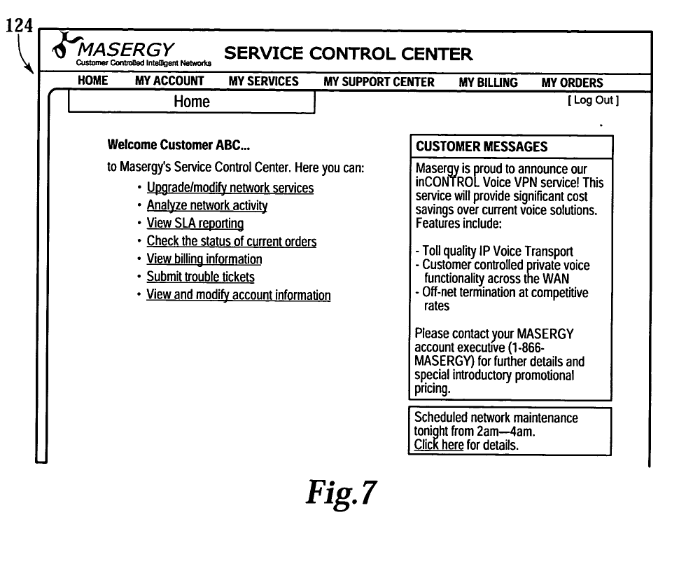

FIGS. 7-13 are examples of interface screens 124 for a customer web portal, through which a customer may provision for itself services on a network, such as network 10 of FIG. 1. Generally, these screens are self-explanatory and are intended to be merely examples. Provided below are brief descriptions of them.

FIG. 7 is a “home” screen. It includes a list form which a customer may select other screens to modify its services, analyze its own network activity, or view billing information, among other things.

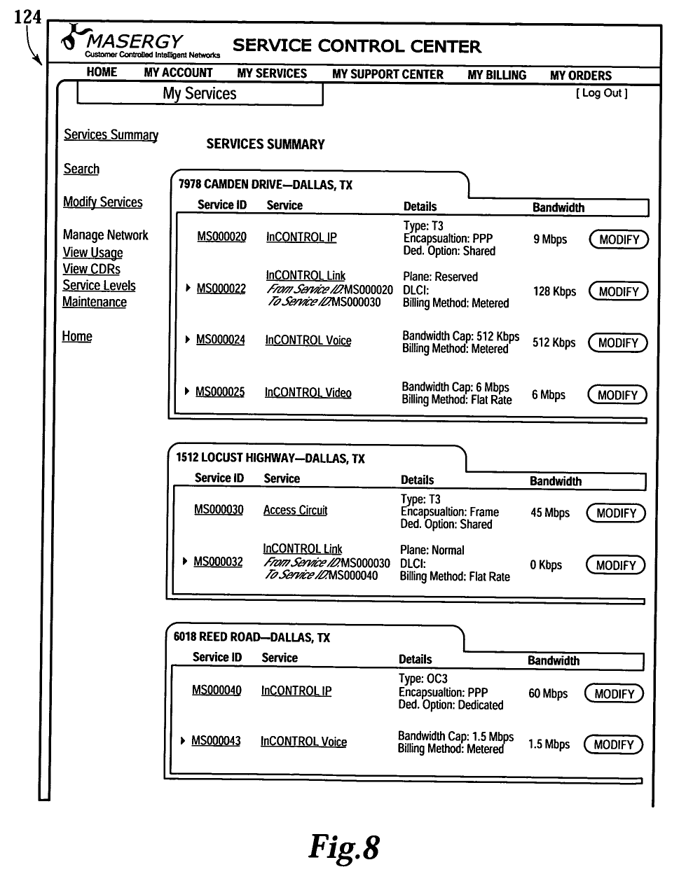

FIG. 8 is a screen shown summarizing the services of a particular customer. The customer in this example has three sites. Under each site are listed is a basic service for the sites access circuit, including the type of access circuit and the type of service offered over that circuit. For example, the first two sites have a T3 line and the third has a OC3 line. The types of services that are listed include basic IP service, labeled “inControl IP”, priority service (labeled “inControl Link”), voice and video (labeled “inControl Voice” and “inControl Video”, respectively). These are examples only. Many other predefined services could be made available to a customer to chose from.

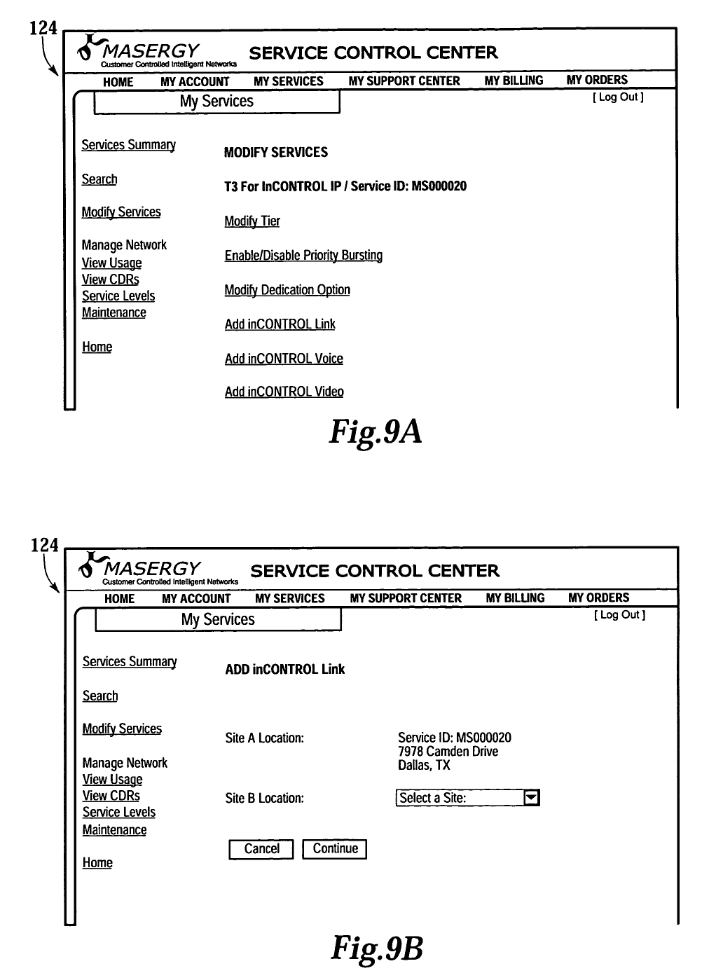

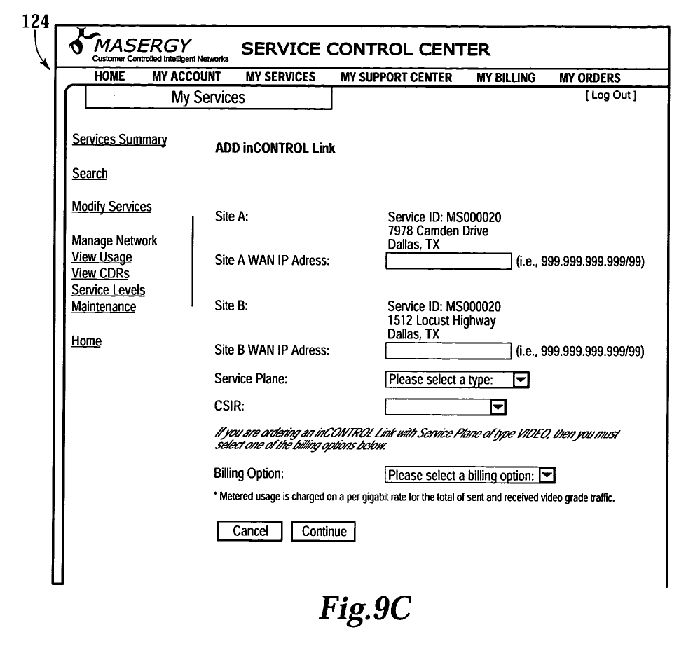

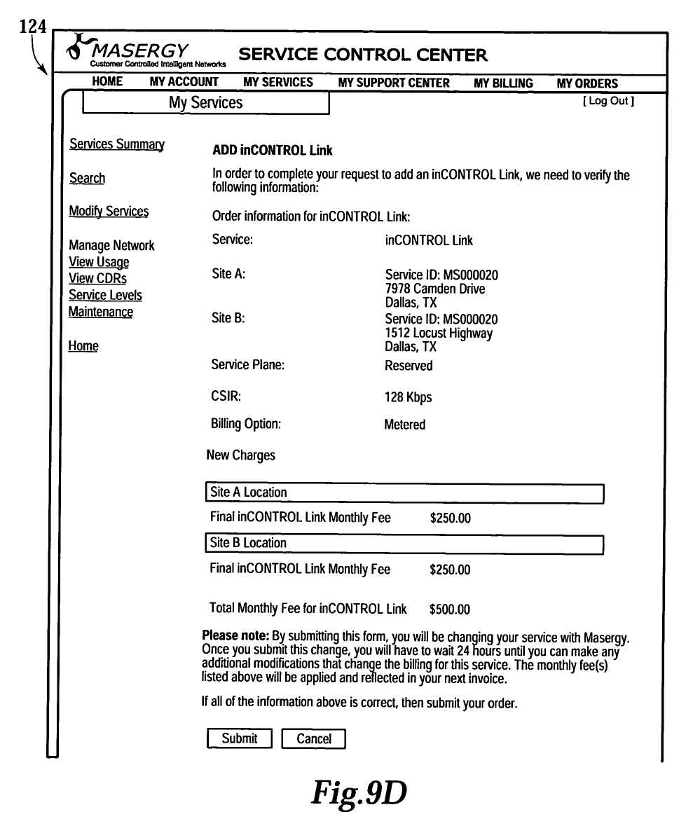

FIG. 9A is a screen that is displayed following selection of service 126 in FIG. 8, which has a service ID of “MS000020”. FIG. 9A allows a customer to select a different tier or bandwidth for the access circuit, enable/disable priority bursting (i.e. allowing the bandwidth to be exceeded for priority traffic) on the access circuit, select whether the circuit is shared or dedicated, and add QoS services for priority, voice or video. As an example of how a service is added, FIG. 9B is the first screen of a process for adding the priority service for the customer site. It allows another of the customer's sites to be specified using a drop down menu. Once a second site is selected, a new screen, shown in FIG. 9C, is presented. WAN IP addresses for the two sites are specified, as well as the CSIR, service plane, and a billing option. Billing options may include, for example, metered and flat rate billing options. FIG. 9D is a summary page for the change.

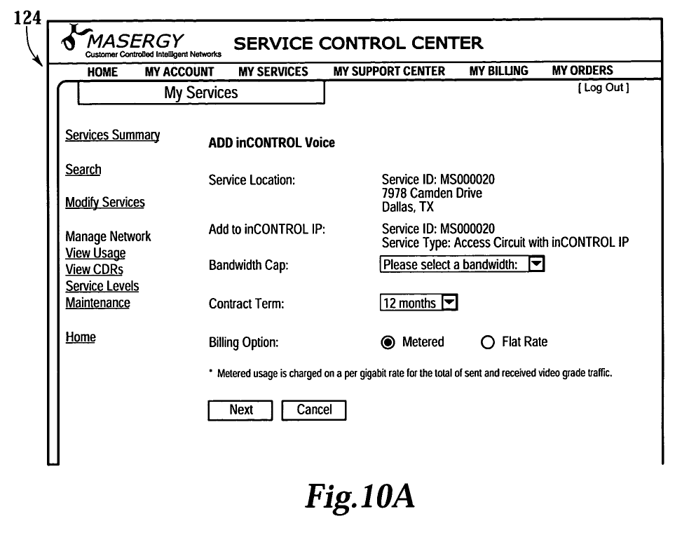

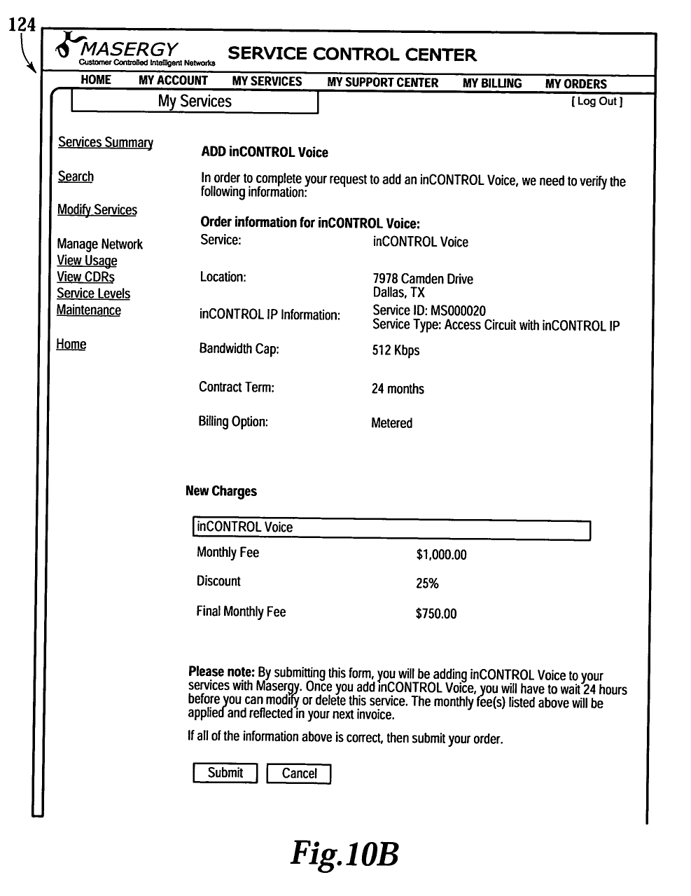

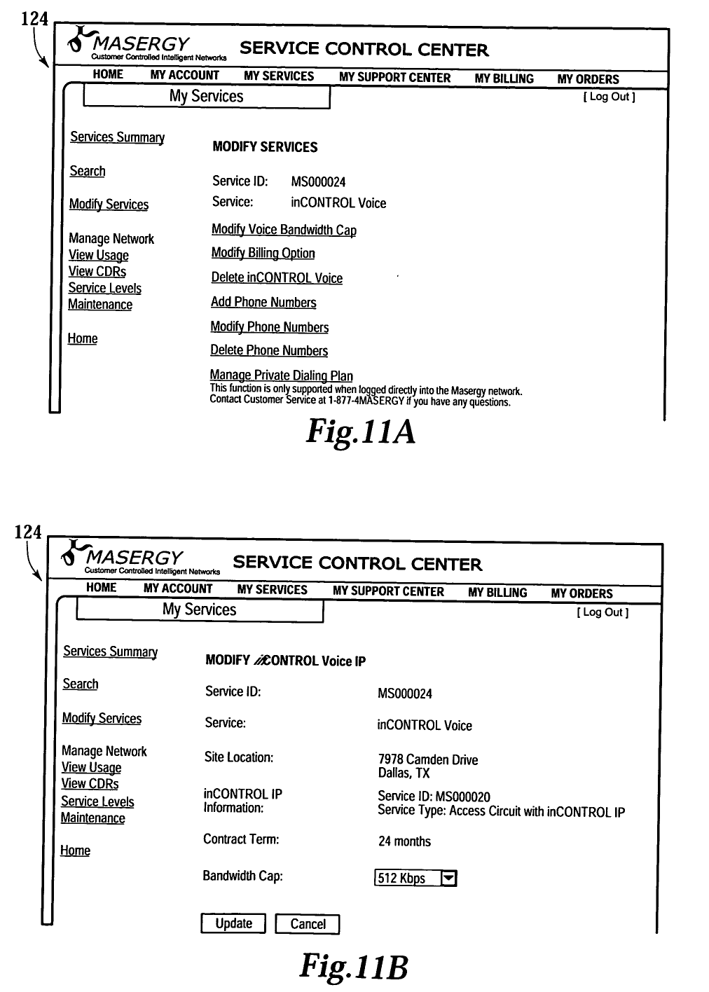

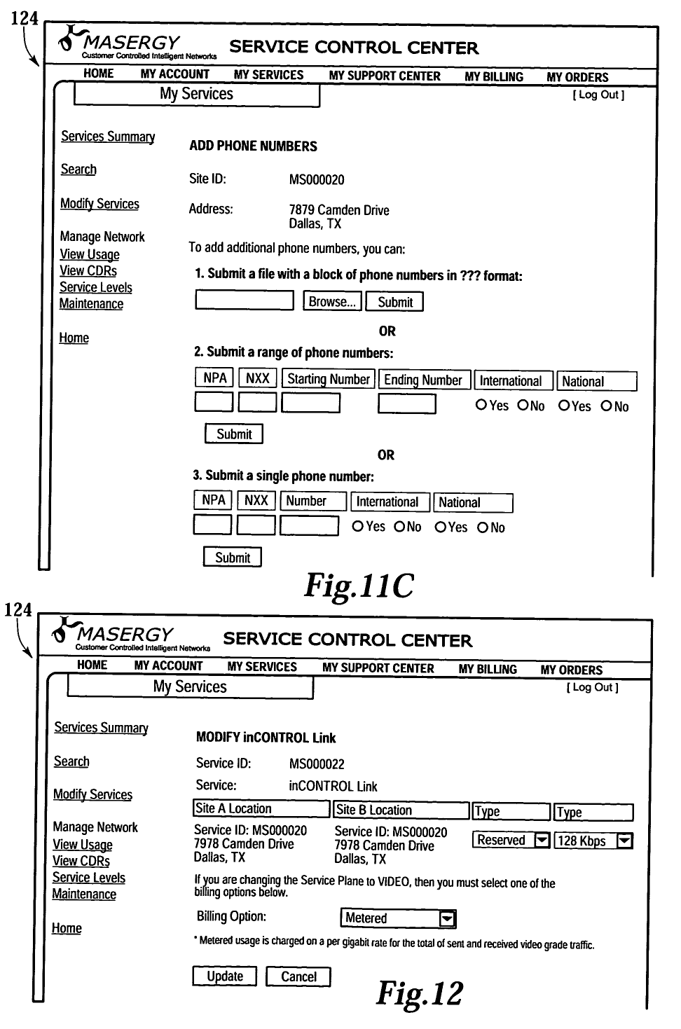

FIGS. 10A is an example of a screen by which a customer may add voice service at a particular site. The customer specifies a bandwidth cap, a contract term and a billing option in the example. FIG. 10B summarizes the new service before it is submitted. The screen in FIG. 11A allows modification of the added voice service. Modification of the bandwidth cap and the billing option previously specified are available, as well as an option to cancel the services. Phone numbers may also be added, modified, or deleted. A private dialing plan may also be available for management. This allows private telephone numbers to be used between the customer sites. FIG. 11B shows the screen for modifying the bandwidth cap. FIG. 11C shows the screen for adding telephone numbers.

FIG. 12 is a screen for modifying a previously added priority service between two sites. A drop down lists for type of priority (e.g. low, medium, high or reserved) and CSIR are available for a customer to select from. A billing option may also be specified using a drop down list.

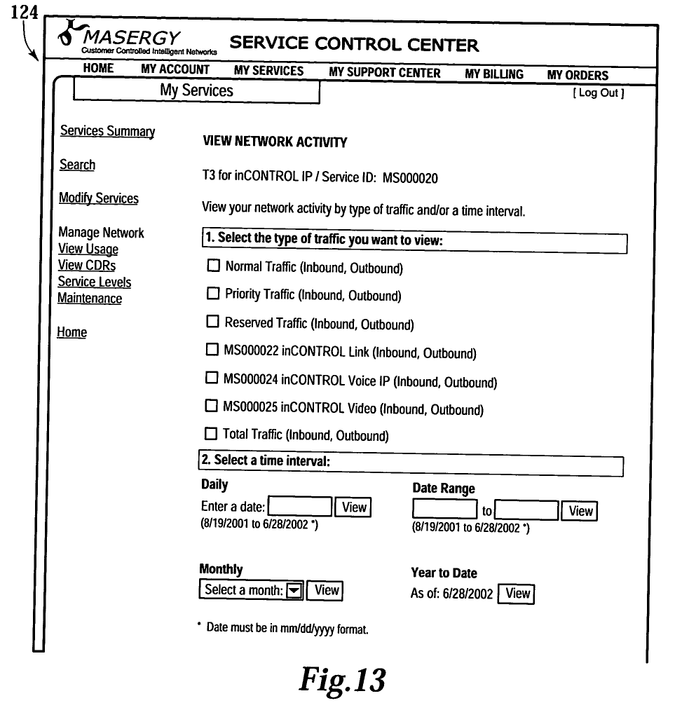

FIG. 13 is a screen for generating a report on traffic for each of the services on a particular access circuit, allowing a customer to determine whether any of the settings for any of the services should be modified, whether any should be dropped, or whether any should be added.

Embodiments of the present invention may be implemented in software, hardware, application logic or a combination of software, hardware and application logic. If desired, the different functions discussed herein may be performed in any order and/or concurrently with each other. Furthermore, if desired, one or more of the above-described functions may be optional or may be combined without departing from the scope of the present invention.

What is claimed is:

1. A method, comprising:
receiving a service request for adding, modifying or canceling a packet transport service having defined service levels of one or more packet networks; and
automatically generating configuration data for one or more of a plurality of network elements of said one or more packet networks necessary for implementing the service request.

2. The method of claim 1, further comprising automatically determining which of the plurality of network elements will be affected by the service request.

3. The method of claim 1, wherein automatically generating configuration data includes generating confirmation data based at least in part on data from a network database storing current configuration data for said one or more network elements.

4. The method of claim 1, wherein automatically generating configuration data further comprises automatically generating said configuration data based at least in part on a predefined script.

5. The method of claim 1 wherein generating configuration data includes populating predefined templates with data from a network database storing configuration data on the one or more network elements and new configuration data based on the service request.

6. The method of claim 5, further comprising running one or more automated routines for automatically populating the templates with data from the network database and the new data.

7. The method of claim 1, further comprising verifying that said configuration data is consistent with a configuration of said one or more packet networks.

8. The method of claim 1, further comprising updating a network database, storing configuration data for said one or more network elements with said generated configuration data.

9. The method of claim 1, further comprising automatically updating a configuration of said one or more network elements based with generated configuration data.

10. The method of claim 9, further comprising verifying that said updated configuration of said one or more network elements is consistent with configuration data, for said one or more network elements, stored in a network database.

11. The method of claim 10, wherein said verifying step comprises:
retrieving said configuration data regarding said one or more network elements from said network database;
identifying one or more fields in said updated configuration of said one or more network elements; and
comparing values of said one or more identified fields with values of corresponding fields in said retrieved configuration data.

12. The method of claim 11, further comprising generating an exception in response to said values of said one or more identified fields not matching said values of corresponding fields in said retrieved configuration data.

13. A method for generating a network element specific configuration, comprising:
receiving a request for adding, modifying or canceling a service on one or more pocket networks;
updating, upon receiving said request, one or more corresponding objects for said service in a network database comprising of network element inventory data for a plurality of network elements of said one or more packet networks;
determining which ones of said plurality of network elements are affected by said request; and
automatically generating configuration data, for each of said one or more affected network elements, from at least said network element inventory data and one or more of a plurality of template fragments comprising predefined configuration text.

14. The method of claim 13, further comprising retrieving one or more selected script objects from a plurality of script objects, each of said selected script objects specifying a network element specific script for a corresponding one of said one or more affected network elements.

15. The method of claim 14, further comprising obtaining abstract connectivity information for each of said one or more affected network elements from said network database.

16. The method of claim 15, wherein said abstract connectivity information specifies a manner of connection between said one or more affected network elements.

17. The method of claim 16, wherein said automatically generating configuration data further comprises:
selecting said one or more of said plurality of template fragments; and
assembling said selected template fragments into a template.

18. The method of claim 17, further comprising populating said assembled template with said network element inventory data.

19. The method of claim 13, further comprising communicating said configuration data to each of said one or more affected network elements.

20. The method of claim 19, wherein said automatically generating step is performed prior to said communicating step.

21. Computer readable media storing instructions that when read a computer enable the computer to undertake a method comprising:
receiving a service request for adding, modifying or canceling a packet transport service having defined service levels of one or more packet networks; and
automatically generating configuration data for one or more of a plurality of network elements of said one or more packet networks necessary for implementing the service request.

22. The computer readable media of claim 21, wherein the method further comprises automatically determining which of the plurality of network elements will be affected by the service request.

23. The computer readable media of claim 21, wherein automatically generating configuration data includes generating confirmation data based at least in part on data from a network database storing current configuration data for said one or more network elements.

24. The computer readable media of claim 21, wherein automatically generating configuration data further comprises automatically generating said configuration data based at least in part on a predefined script.

25. The computer readable media of claim 21, wherein generating configuration data includes populating predefined templates with data from a network database storing configuration data on the one or more network elements and new configuration data based on the service request.

26. The computer readable media of claim 25, wherein the method further comprises comprising running one or more automated routines for automatically populating the templates with data from the network database and the new data.

27. A computer readable storage medium comprising:
stored metadata for describing elements of a pocket network, relationships between the elements of the packet network, and types of properties to be stored with respect to each element of the packet network; and
fields defined by the metadata for storing configuration data.
